(19) United States
(12) Patent Application Publication
(10) Pub. No.: US 2019/0303652 A1
(43) Pub. Date: Oct. 3, 2019

(54) MULTI-VIEW FACE RECOGNITION SYSTEM AND RECOGNITION AND LEARNING METHOD THEREFOR

(71) Applicant: Goldtek Technology Co., Ltd., New Taipei City (TW)

(72) Inventors: PO-SHENG WANG, New Taipei (TW); DARWIN KURNIAWAN OH, New Taipei (TW)

(21) Appl. No.: 16/255,298

(22) Filed: Jan. 23, 2019

(30) Foreign Application Priority Data
Mar. 29, 2018 (TW) 107111063

(51) Int. Cl. G06K 9/00; G06N 20/00

(52) U.S. Cl. CPC G06K 9/00255; G06N 20/00; G06K 9/00288

(57) ABSTRACT

A face recognition system includes a first camera, a second camera, and a recognition engine. The first camera is configured to capture a first facial image of a first view. The second camera is configured to capture a second facial image of a second view. The recognition engine includes a first recognition module, a second recognition module, and a decision module. The first recognition module is configured to generate a first weighting factor based on the first view. The second recognition module is configured to generate a second weighting factor based on the second view. The decision module is configured to generate a comparison model based on the first facial image, the second facial image, the first weighting factor, and the second weighting factor. The face recognition system uses the plurality of cameras to capture the facial images of different views to achieve highly accurate recognition.

### FIELD

The present disclosure relates to facial recognition technology, and more particularly to a multi-view face recognition system and a recognition and learning method therefor.

### BACKGROUND

Face recognition is a biometric technology that can identify or verify a person from a digital image or a video frame from a video source. Face recognition is used in a wide range of applications such as identity verification, access control, and surveillance. However, the face recognition system often uses a single camera to capture a frontal facial image and may not be able to recognize a face from other views, resulting in recognition errors.

Therefore, there is room for improvement within the art.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a schematic diagram of an embodiment of a face recognition system.

FIG. 2 is a schematic diagram of another embodiment of a face recognition system.

FIG. 3 is a block diagram of an embodiment of a recognition engine of a face recognition system.

FIG. 4 is a flowchart of an embodiment of a recognition method for a face recognition system.

FIG. 5 is a flowchart of another embodiment of a recognition method for a face recognition system.

FIG. 6 is a flowchart of an embodiment of a learning method for a face recognition system.

FIG. 7 is a flowchart of another embodiment of a learning method for a face recognition system.

FIG. 8 is a flowchart of yet another embodiment of a learning method for a face recognition system.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

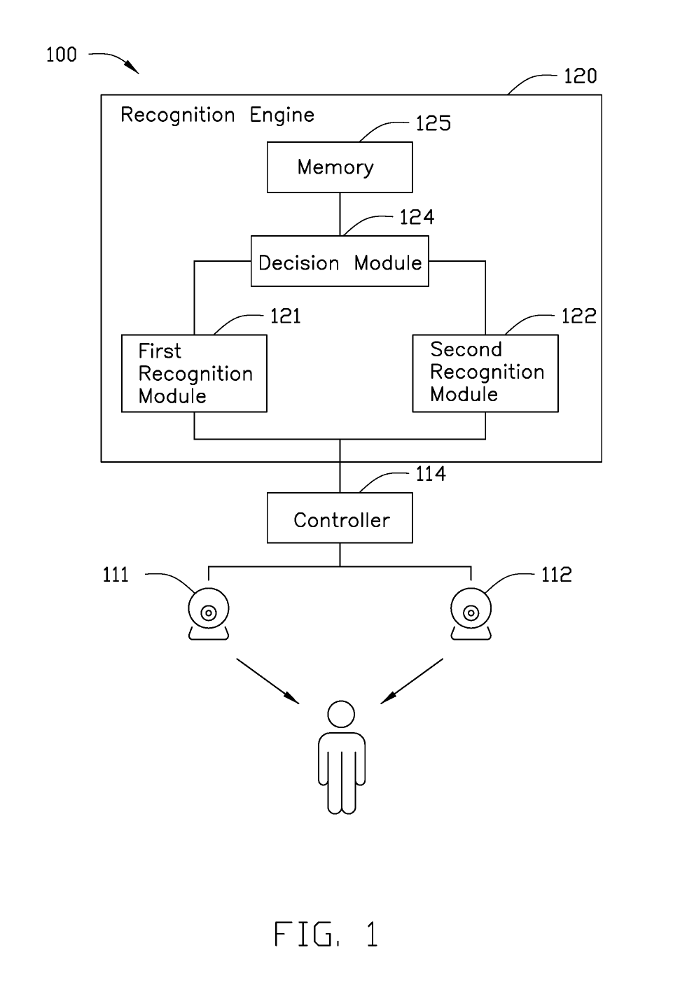

FIG. 1 is a schematic diagram of an embodiment of a face recognition system. As shown in FIG. 1, a face recognition system 100 uses 3D sensing technology and includes a plurality of cameras, a recognition engine 120, and a controller 114.

The plurality of cameras includes a first camera 111 and a second camera 112. The first camera 111 is configured to capture a first facial image of a first view. The second camera 112 is configured to capture a second facial image of a second view.

The recognition engine 120 is coupled to the first camera 111 and the second camera 112. The recognition engine 120 includes a plurality of recognition modules, a decision module 124, and a memory 125. The plurality of recognition modules includes a first recognition module 121 and a second recognition module 122. A number of recognition modules corresponds to a number of cameras. The first recognition module 121 is configured to generate a first weighting factor based on the first view. The second recognition module 122 is configured to generate a second weighting factor based on the second view. The decision module 124 is configured to generate a comparison model based on the first facial image multiplied by the corresponding first weighting factor and the second facial image multiplied by the corresponding second weighting factor. The decision module 124 can generate the comparison model using machine learning, such as deep learning. The memory 125 is configured to store the comparison model.

The controller 114 is coupled to the first camera 111, the second camera 112, and the recognition engine 120. The controller 114 is configured to control the first camera 111 and the second camera 112.

In use, a face can be located in a middle between the first camera 111 and the second camera 112. When the first camera 111 detects the presence of the face, the controller 114 activates the first camera 111 and the second camera 112 to capture facial images. The first camera 111 can capture the first facial image of one side (e.g., left side) of the face and the second camera 112 can capture the second facial image of the other side (e.g., right side) of the face. Additionally, the first recognition module 121 generates the first weighting factor of 50% based on the side view and the second recognition module 122 generates the second weighting factor of 50% based on the other side view.

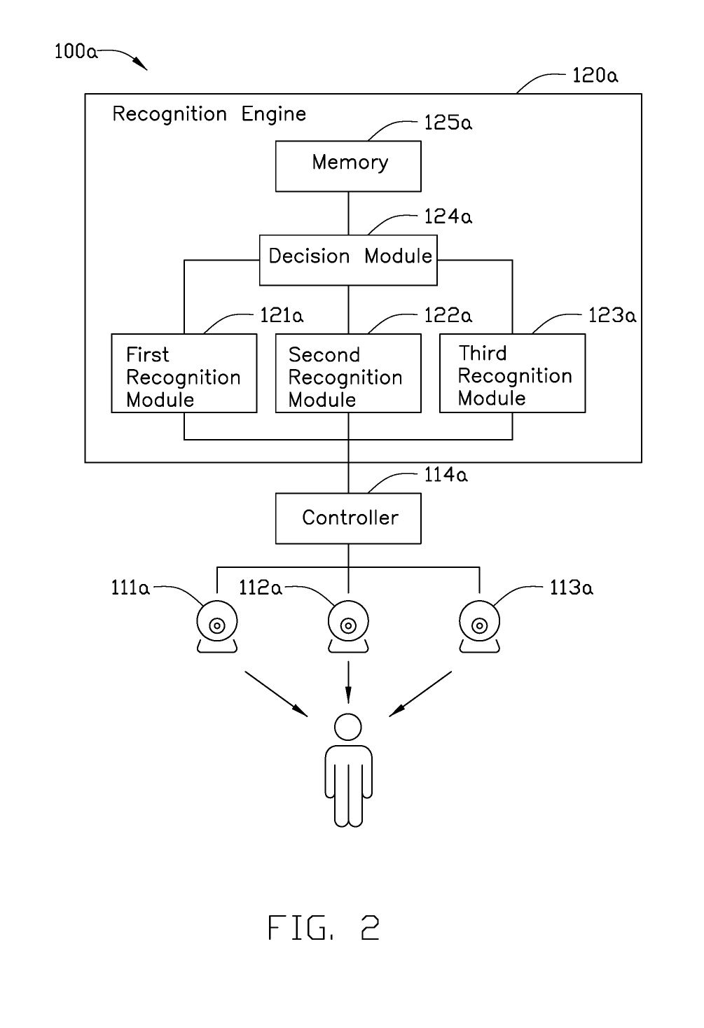

FIG. 2 is a schematic diagram of another embodiment of a face recognition system. The difference between the embodiment of FIG. 2 and the embodiment of FIG. 1 is that the plurality of cameras of FIG. 2 further includes a third camera 113a and the plurality of recognition modules of FIG. 2 further includes a third recognition module 123a. The third camera 113a is configured to capture a third facial image of a third view. The recognition engine 120 is coupled to the third camera 113a. The third recognition module 123a is configured to generate a third weighting factor based on the third view. The decision module 124a is configured to generate the comparison model based on the first facial image multiplied by the corresponding first weighting factor, the second facial image multiplied by the corresponding second weighting factor, and the third facial image multiplied by the corresponding third weighting factor. In use, the first camera 111a can capture the first facial image of one side of the face, the second camera 112a can capture the second facial image of a front view of the face, and the third camera 113a can capture the third facial image of the other side of the face. Additionally, the first recognition module 121a generates the first weighting factor of 30% based on the side view, the second recognition module 122a generates the second weighting factor of 40% based on the front view, and the third recognition module 123a generates the third weighting factor of 30% based on the other side view.

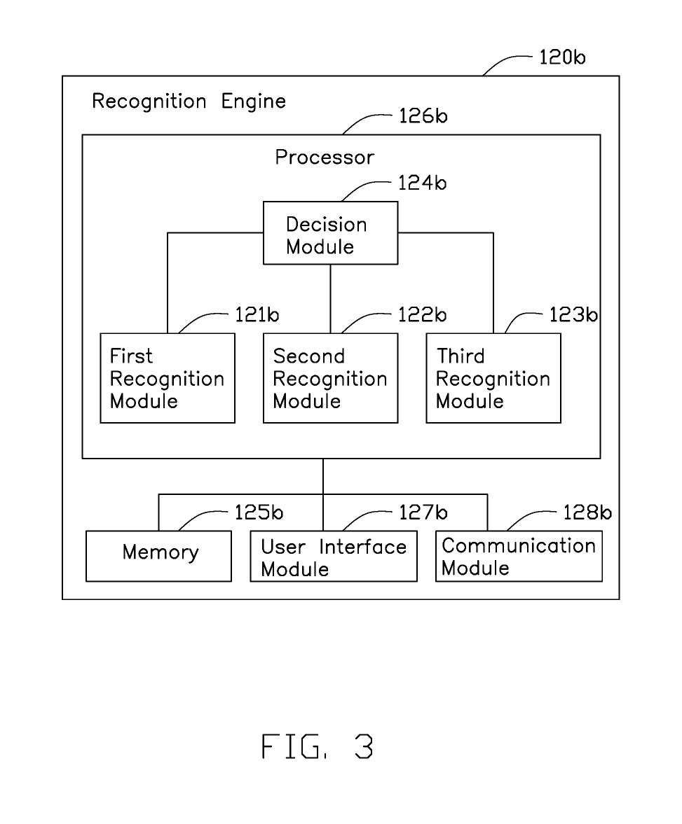

FIG. 3 is a block diagram of an embodiment of a recognition engine of a face recognition system. As shown in FIG. 3, a recognition engine 120b can be a computer or a server. The recognition engine 120b includes a processor 126b, a memory 125b, a user interface module 127b, and a communication module 128b. The processor 126b is configured to control the memory 125b, the user interface module 127b, and the communication module 128b. The processor 126b further includes a first recognition module 121b, a second recognition module 122b, a third recognition module 123b, and a decision module 124b. The user interface module 127b provides an interface for interacting with the recognition engine 120b. The communication module 128b is configured to receive or transmit data, such as the data of the facial images.

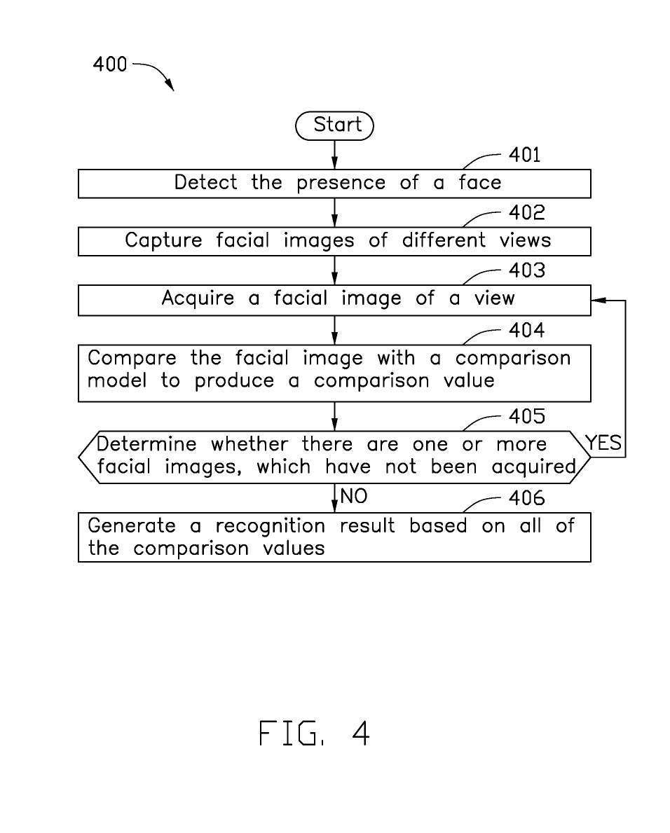

FIG. 4 is a flowchart of an embodiment of a recognition method for a face recognition system. As shown in FIG. 4, a recognition method 400 includes the following processes 401-406.

In process 401, one of a plurality of cameras detects the presence of a face.

In process 402, the cameras are activated to capture facial images of different views.

In process 403, one of a plurality of recognition modules acquires a facial image of a view captured by a corresponding camera.

In process 404, the recognition module compares the facial image with a comparison model to produce a comparison value.

In process 405, a recognition engine determines whether there are one or more facial images captured by the other one or more cameras, which have not been acquired by the recognition modules. If the determination is YES, process 405 loops back to process 403 to continue acquiring a facial image of another view. If the determination is No, process 405 proceeds to process 406.

In process 406, a decision module generates a recognition result based on all of the comparison values produced by the recognition modules.

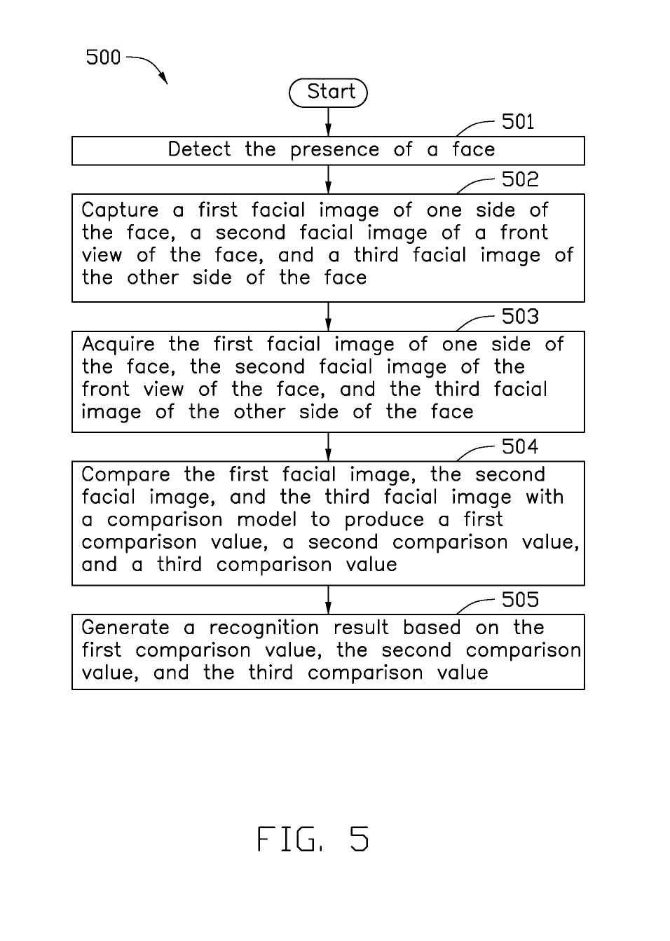

FIG. 5 is a flowchart of another embodiment of a recognition method for a face recognition system. As shown in FIG. 5, a recognition method 500 includes the following processes 501-505. The recognition method 500 is applicable to the face recognition system 100a of FIG. 2.

In process 501, the second camera 112a detects the presence of a face.

In process 502, the controller 114a activates the first camera 111a, the second camera 112a, and the third camera 113a. The first camera 111a captures the first facial image of one side of the face, the second camera 112a captures the second facial image of the front view of the face, and the third camera 113a captures the third facial image of the other side of the face.

In process 503, the first recognition module 121a acquires the first facial image of one side of the face, the second recognition module 122a acquires the second facial image of the front view of the face, and the third recognition module 123a acquires the third facial image of the other side of the face.

In process 504, the recognition engine 120a compares the first facial image, the second facial image, and the third facial image with a comparison model to produce a first comparison value, a second comparison value, and a third comparison value. More specifically, the first recognition module 121a compares the first facial image of one side of the face with the comparison model to produce the first comparison value. The second recognition module 122a compares the second facial image of the front view of the face with the comparison model to produce the second comparison value. The third identification module 123a compares the third facial image of the other side of the face with the comparison model to produce the third comparison value.

In process 505, the decision module 124a generates a recognition result based on the first comparison value, the second comparison value, and the third comparison value.

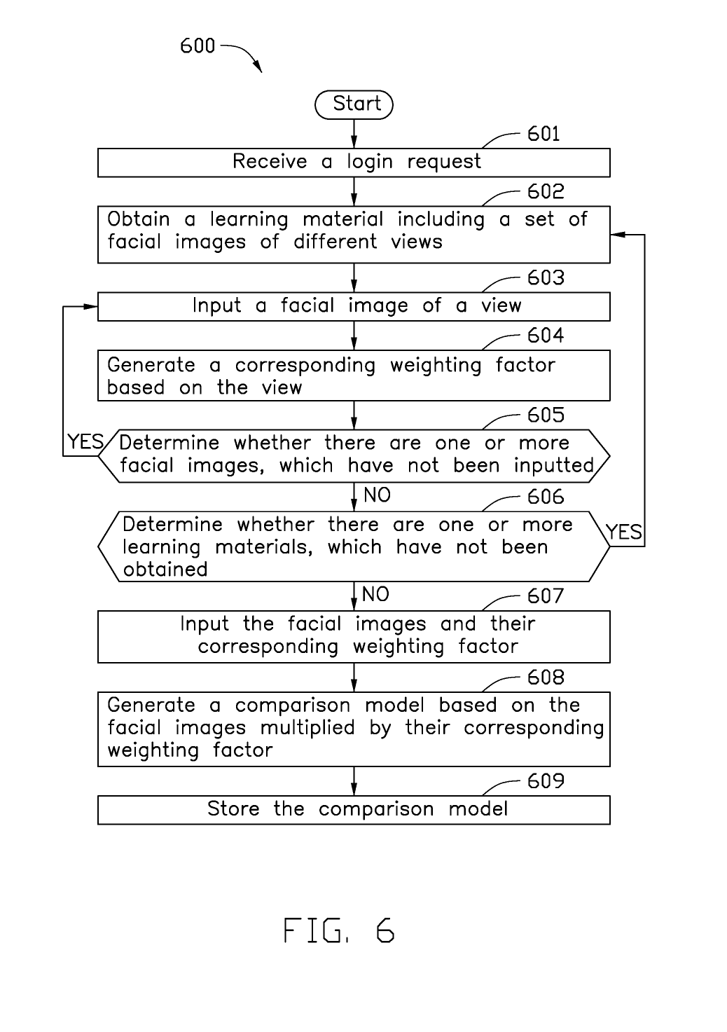

FIG. 6 is a flowchart of an embodiment of a learning method for a face recognition system. As shown in FIG. 6, a learning method 600 includes the following processes 601-609.

In process 601, a recognition engine receives a login request.

In process 602, the recognition engine obtains a learning material including a set of facial images of different views captured by a plurality of cameras.

In process 603, the recognition engine inputs a facial image of a view captured by one of the cameras into one of a plurality of recognition modules.

In process 604, the recognition module generates a corresponding weighting factor based on the view.

In process 605, the recognition engine determines whether there are one or more facial images captured by the other one or more cameras, which have not been inputted into the recognition modules. If the determination is YES, process 605 loops back to process 603 to continue inputting a facial image of another view. If the determination is No, process 605 proceeds to process 606.

In process 606, the recognition engine determines whether there are one or more learning materials, which have not been obtained by the recognition engine. If determination is YES, process 606 loops back to process 602 to continue obtaining another learning material. If the determination is NO, process 606 proceeds to process 607.

In process 607, the recognition engine inputs the facial images and their corresponding weighting factor into a decision module.

In process 608, the decision module generates a comparison model based on the facial images multiplied by their corresponding weighting factor.

In process 609, the memory stores the comparison model.

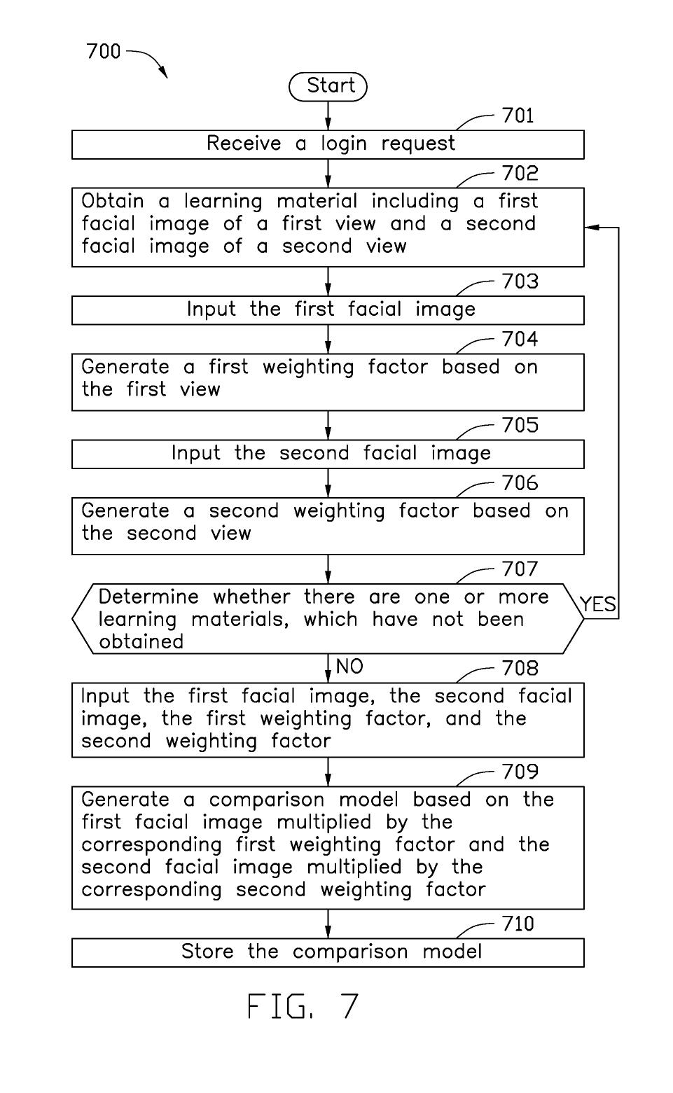

FIG. 7 is a flowchart of another embodiment of a learning method for a face recognition system. As shown in FIG. 7, a learning method 700 includes the following processes 701-710. The learning method 700 is applicable to the face recognition system 100 of FIG. 1.

In process 701, the recognition engine 120 receives a login request.

In process 702, the recognition engine 120 obtains a learning material including the first facial image of the first view captured by the first camera 111 and the second facial image of the second view captured by the second camera 112.

In process 703, the recognition engine 120 inputs the first facial image into the first recognition module 121.

In process 704, the first recognition module 121 generates the first weighting factor based on the first view.

In process 705, the recognition engine 120 inputs the second facial image into the second recognition module 122.

In process 706, the second recognition module 122 generates the second weighting factor based on the second view.

In process 707, the recognition engine 120 determines whether there are one or more learning materials, which have not been obtained by the recognition engine 120. If determination is YES, process 707 loops back to process 702 to continue obtaining another learning material. If the determination is NO, process 707 proceeds to process 708.

In process 708, the recognition engine 120 inputs the first facial image, the second facial image, the first weighting factor, and the second weighting factor into the decision module 124.

In process 709, the decision module 124 generates the comparison model based on the first facial image multiplied by the corresponding first weighting factor and the second facial image multiplied by the corresponding second weighting factor.

In process 710, the memory 125 stores the comparison model.

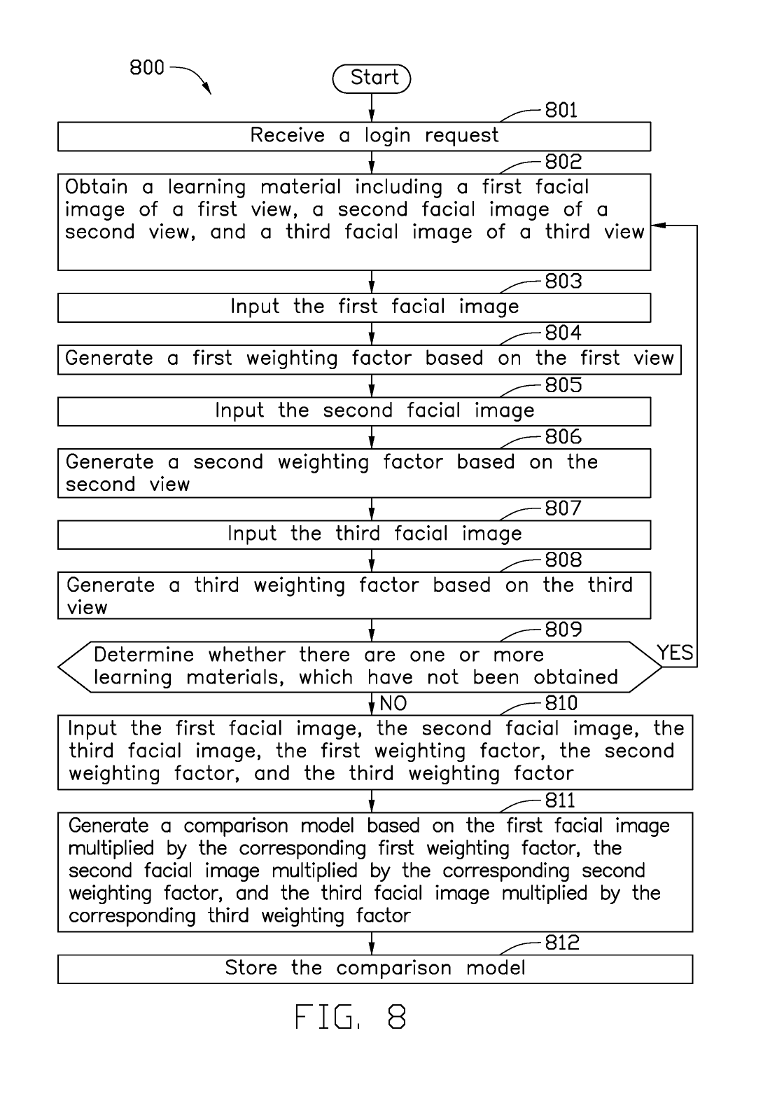

FIG. 8 is a flowchart of yet another embodiment of a learning method for a face recognition system. As shown in FIG. 8, a learning method 800 includes the following processes 801-812. The learning method 800 is applicable to the face recognition system 100a of FIG. 2.

In process 801, the recognition engine 120a receives a login request.

In process 802, the recognition engine 120a obtains a learning material including the first facial image of the first view captured by the first camera 111a, the second facial image of the second view captured by the second camera 112a, and the third facial image of the third view captured by the third camera 113a.

In process 803, the recognition engine 120a inputs the first facial image into the first recognition module 121a.

In process 804, the first recognition module 121a generates the first weighting factor based on the first view.

In process 805, the recognition engine 120a inputs the second facial image into the second recognition module 122a.

In process 806, the second recognition module 122a generates the second weighting factor based on the second view.

In process 807, the recognition engine 120a inputs the third facial image into the third recognition module 123a.

In process 808, the third recognition module 123a generates the third weighting factor based on the third view.

In process 809, the recognition engine 120a determines whether there are one or more learning materials, which have not been obtained by the recognition engine 120a. If determination is YES, process 809 loops back to process 802 to continue obtaining another learning material. If the determination is NO, process 809 proceeds to process 810.

In process 810, the recognition engine 120a inputs the first facial image, the second facial image, the third facial image, the first weighting factor, the second weighting factor, and the third weighting factor into the decision module 124a.

In process 811, the decision module 124a generates the comparison model based on the first facial image multiplied by the corresponding first weighting factor, the second facial image multiplied by the corresponding second weighting factor, and the third facial image multiplied by the corresponding third weighting factor.

In process 812, the memory 125a stores the comparison model.

The embodiments shown and described above are only examples. Many details are often found in this field of art thus many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A face recognition system comprising:
a first camera configured to capture a first facial image of a first view; and
a second camera configured to capture a second facial image of a second view; and
a recognition engine coupled to the first camera and the second camera, and the recognition engine comprising:
a first recognition module configured to generate a first weighting factor based on the first view; and
a second recognition module configured to generate a second weighting factor based on the second view; and
a decision module configured to generate a comparison model based on the first facial image, the second facial image, the first weighting factor, and the second weighting factor.

2. The face recognition system of claim 1,
wherein the first camera is configured to capture the first facial image of one side of a face; and
wherein the second camera is configured to capture the second facial image of the other side of the face.

3. The face recognition system of claim 1, further comprising a third camera configured to capture a third facial image of a third view;
wherein the recognition engine is coupled to the third camera, and the recognition engine further comprises a third recognition module configured to generate a third weighting factor based on the third view; and
wherein the decision module is configured to generate the comparison model based on the first facial image, the second facial image, the third facial image, the first weighting factor, the second weighting factor, and the third weighting factor.

4. The face recognition system of claim 3,
wherein the first camera is configured to capture the first facial image of one side of a face;
wherein the second camera is configured to capture the second facial image of a front view of the face; and
wherein the third camera is configured to capture the third facial image of the other side of the face.

5. The face recognition system of claim 1, further comprising a controller coupled to the first camera, the second camera, and the recognition engine for controlling the first camera and the second camera.

6. The face recognition system of claim 1, wherein the recognition engine further comprises a memory for storing the comparison model.

7. A recognition method for a face recognition system comprising:
capturing a first facial image of a first view by a first camera, and capturing a second facial image of a second view by a second camera;
comparing the first facial image and the second facial image with a comparison model by a recognition engine and producing a first comparison value and a second comparison value; and
generating a recognition result based on the first comparison value and the second comparison value by the recognition engine.

8. The recognition method of claim 7, wherein the recognition engine comprises a first recognition module acquiring the first facial image and a second recognition module acquiring the second facial image.

9. The recognition method of claim 8,
wherein the first camera captures the first facial image of one side of a face; and
wherein the second camera captures the second facial image of the other side of the face.

10. The recognition method of claim 7,
wherein the recognition engine compares a third facial image of a third view captured by a third camera with the comparison model and produces a third comparison value; and
wherein the recognition engine generates the recognition result based on the first comparison value, the second comparison value, and the third comparison value.

11. The recognition method of claim 10, wherein the recognition engine comprises a first recognition module acquiring the first facial image, a second recognition module acquiring the second facial image, and a third recognition module acquiring the third facial image.

12. The recognition method of claim 11,
wherein the first camera captures the first facial image of one side of a face;
wherein the second camera captures the second facial image of a front view of the face; and
wherein the third camera captures the third facial image of the other side of the face.

13. A learning method for a face recognition system comprising:
obtaining a learning material by a recognition engine in which the learning material comprises a first facial image of a first view captured by a first camera and a second facial image of a second view captured by a second camera;
generating a first weighting factor based on the first view by a recognition engine;
generating a second weighting factor based on the second view by the recognition engine;
generating a comparison model based on the first facial image, the second facial image, the first weighting factor, and the second weighting factor by the recognition engine; and
storing the comparison model by the recognition engine.

14. The learning method of claim 13,
wherein the first camera captures the first facial image of one side of a face; and
wherein the second camera captures the second facial image of the other side of the face.

15. The learning method of claim 13,
wherein the learning material further comprises a third facial image of a third view captured by a third camera;
wherein the recognition engine generates a third weighting factor based on the third view, and then generates the comparison model based on the first facial image, the second facial image, the third facial image, the first weighting factor, the second weighting factor, and the third weighting factor.

16. The learning method of claim 15,
wherein the first camera captures the first facial image of one side of a face;
wherein the second camera captures the second facial image of a front view of the face; and
wherein the third camera captures the third facial image of the other side of the face.

17. The learning method of claim 13, further comprising determining, by the recognition engine, whether there are one or more learning materials which have not been obtained by the recognition engine, if there are one or more learning material which have not been obtained, obtaining the learning material, and if there are no learning material to be obtained, storing the comparison model.

18. The learning method of claim 14, further comprising determining, by the recognition engine, whether there are one or more learning materials which have not been obtained by the recognition engine, if there are one or more learning material which have not been obtained, obtaining the learning material, and if there are no learning material to be obtained, storing the comparison model.

19. The learning method of claim 15, further comprising determining, by the recognition engine, whether there are one or more learning materials which have not been obtained by the recognition engine, if there are one or more learning material which have not been obtained, obtaining the learning material, and if there are no learning material to be obtained, storing the comparison model.

20. The learning method of claim 16, further comprising determining, by the recognition engine, whether there are one or more learning materials which have not been obtained by the recognition engine, if there are one or more learning material which have not been obtained, obtaining the learning material, and if there are no learning material to be obtained, storing the comparison model.
